(19) United States
(12) Patent Application Publication
(10) Pub. No.: US 2012/0156604 A1
(43) Pub. Date: Jun. 21, 2012

(54) ELECTROPHOTOGRAPHIC CLEAR TONER AND IMAGE FORMING METHOD

(75) Inventors: Makoto Fukatsu, Suntou-gun (JP); Yasunori Chigono, Atsugi-shi (JP); Emi Hagiwara, Yokohama-shi (JP); Shintarou Ishida, Toda-shi (JP)

(73) Assignee: CANON KABUSHIKI KAISHA, Tokyo (JP)

(21) Appl. No.: 13/315,479

(22) Filed: Dec. 9, 2011

(30) Foreign Application Priority Data
Dec. 15, 2010 (JP) 2010-278807

(51) Int. Cl. G03G 9/00; G03G 15/20

(52) U.S. Cl. 430/105; 399/341; 430/124.1

(57) ABSTRACT

Provide is a clear toner having a wide fixing temperature latitude so as to improve the degree of glossiness in a wide range of image density areas, from a white portion to a high image density portion, while ensuring sufficient fixing performance and color mixing in color portions. The clear toner has a storage elastic modulus G′ (130) of 1.0×10⁴ Pa or more at 130° C. and a melt viscosity η (130) of 1.0×10⁴ Pa·s or less at 130° C.

### BACKGROUND OF THE INVENTION

1. Field of the Invention

The present invention relates to a clear toner to be used in an image forming method employing an electrophotographic method for a copying machine, a printer, a fax machine, a multifunctional machine thereof, and the like. The present invention also relates to an image forming method using the clear toner.

2. Description of the Related Art

Conventionally, image forming apparatuses, such as copying machines and printers, using an electrophotographic method are widely known. A large number of image forming apparatuses capable of not only black-and-white image forming but also full-color image forming have been commercialized. In addition, along with the use of the image forming apparatuses employing the electrophotographic method in various fields, there have also been demands for advanced image quality.

Among such demands, in response to diversification of output images, a technology is sought that partially changes glossiness within the same image surface regardless of image density.

In response to such needs, a technology has been proposed in which glossiness of a white portion area and a highlight tone area on a transfer material is changed by forming an image by transferring and fixing a clear toner together with usual color toners, such as black, yellow, magenta, and cyan (see, for example, Japanese Patent Publication No. H07-038084). Another technology has been proposed in which a white toner image is formed using a white toner containing titanium oxide having an average particle diameter between 0.20 and 0.35 μm (see, for example, Japanese Patent Application Laid-Open No. H01-000574).

To a high density image area, a large amount of toner is applied. If the amount of toner applied is large, fixing becomes difficult. Therefore, in the case of fixing an image with a large amount of toner applied, it is necessary to sufficiently melt a toner image by increasing a fixing temperature used in a fixing step to reduce toner melt viscosity.

However, in the case of using a clear toner to increase a degree of glossiness of a white portion area and a highlight tone area on a transfer material, if fixing is performed under conditions adjusted for an area with a large amount of toner being applied, melting of a clear toner image on the transfer material progresses excessively because the amount of toner being applied is small in a clear toner image area portion. As a result, a resin of the clear toner penetrates into paper fibers of the transfer material, which results in a problem that a desired degree of glossiness cannot be achieved.

When the fixing temperature used in the fixing step is reduced in order to ensure the glossiness in the white portion area, the toner melt viscosity of the clear toner being applied over a toner image in the high density image area is not sufficiently reduced in a fixing part. Therefore, the toner in the high density image area cannot be sufficiently melted. This results in a problem in that the desired degree of glossiness cannot be achieved in the high density image area, and further results in problems of a fixing failure, insufficient progression of color mixing, and the like.

Accordingly, there is a demand for a clear toner capable of improving the degree of glossiness in a wide range of image density areas, from a white portion to a high image density portion, while ensuring sufficient fixing performance and color mixing in color portions.

In addition, in the electrophotography field, it has been conventionally known to form an image on a recording material using a white toner. Further, titanium oxide is often used as white pigments having high hiding power.

However, in the case where a white toner is produced using titanium oxide, the toner assumes hygroscopic characteristics because a small amount of impurities contained in titanium oxide have hygroscopic characteristics. As a result, the electrostatic charge amount of the white toner decreases, which causes image defects, such as fogging.

Although it is possible to reduce moisture absorption of the white toner by reducing the amount of impurities contained in titanium oxide, as proposed in the above-mentioned Japanese Patent Application Laid-Open No. H01-000574, an increase in the degree of purity involves an increase in the production costs of materials. Accordingly, a method is sought for representing white color without using the white toner containing titanium oxide.

### SUMMARY OF THE INVENTION

The present invention has been made in view of the technical problems found in the above-mentioned related art. It is an object of the present invention to provide a clear toner having a wide fixing temperature latitude so as to solve the above-mentioned problems, particularly, to improve the degree of glossiness in a wide range of image density areas, from a white portion to a high image density portion, while ensuring sufficient fixing performance and color mixing in color portions.

It is another object of the present invention to provide an image forming method capable of achieving a high-quality white image free from image defects, such as a fixing failure, without causing a decrease in the electrostatic charge amount due to moisture absorption.

The present invention relates to a clear toner having a storage elastic modulus G′ (130) of 1.0×10⁴ Pa or more at 130° C. and a melt viscosity η (130) of 1.0×10⁴ Pa·s or less at 130° C.

Further, the present invention relates to an image forming method using the above-mentioned clear toner as a clear toner, the image forming method including:

i) fixing an unfixed toner image onto a transfer material by bringing a fixing member into direct contact with the unfixed toner image on the transfer material;
ii) fixing an unfixed toner image onto a transfer material without bringing a fixing member into direct contact with the unfixed toner image on the transfer material; and
iii) obtaining a fixed toner image by bringing a fixing member into direct contact with a first unfixed toner image on a transfer material, subsequently forming a second unfixed toner image on the same surface of the transfer material, and fixing the second unfixed toner image onto the transfer material without bringing a fixing member into direct contact with the second unfixed toner image on the transfer material.

Accordingly, it is possible to provide the clear toner having a wide fixing temperature latitude so as to improve the degree of glossiness in a wide range of image density areas, from a white portion to a high image density portion, while ensuring excellent fixing performance and color mixing.

Further features of the present invention will become apparent from the following description of exemplary embodiments with reference to the attached drawings.

### BRIEF DESCRIPTION OF THE DRAWINGS

FIG. 1 is a schematic configuration diagram of an image forming apparatus.

FIG. 2 is an enlarged schematic diagram of a part corresponding to an image forming part and an intermediate transfer belt mechanical part.

FIG. 3 is an enlarged schematic diagram of a part corresponding to a fixing device.

FIG. 4 is a schematic configuration diagram of an image data forming unit.

FIG. 5 is a schematic configuration diagram of an image forming apparatus according to Example 4.

FIG. 6 is an enlarged schematic diagram of a part corresponding to a fixing device according to Example 4.

FIG. 7 is a schematic configuration diagram of an image data forming unit.

FIG. 8 is a schematic configuration diagram of an image forming apparatus according to Example 5.

FIG. 9 is a schematic configuration diagram of an image forming apparatus according to Example 6.

### DESCRIPTION OF THE EMBODIMENTS

Preferred embodiments of the present invention will now be described in detail in accordance with the accompanying drawings.

As a result of keen examination, the inventors of the present invention have found that the storage elastic modulus of a toner has a significant effect on excessive penetration into paper fibers of a transfer material. That is, if the storage elastic modulus of the toner in a fixing nip decreases too much, a binding force between melted toner resin particles decreases. Accordingly, when toner resin sinks into the interspace between the paper fibers, binding between each toner resin particle and its neighboring toner resin particle cannot be maintained, which facilitates the toner resin to penetrate into the paper fibers.

In addition, the inventors have found that toner melt viscosity η has a significant effect on the degree of glossiness of the toner on the transfer material. It may be conceivable that, by sufficiently reducing the toner melt viscosity η in the fixing nip, melting of the toner resin progresses and the toner melts and spreads, which results in an increase in the degree of glossiness.

The present invention is made based on the above-mentioned findings.

A clear toner of the present invention has a storage elastic modulus G′ (130) of 1.0×10⁴ Pa or more at 130° C. Therefore, when a fixing temperature used in a fixing step is increased, the storage elastic modulus at a fixing part does not decrease excessively. Accordingly, it is possible to prevent the clear toner from excessively penetrating into the paper fibers of the transfer material even when the amount of the clear toner applied to the transfer material is about the same as the toner amount to be applied to a single-colored solid image, thereby achieving a desired degree of glossiness. Note that, it is further preferred that the storage elastic modulus G′ (130) be 2.0×10⁴ Pa or more.

In addition, the clear toner of the present invention has a melt viscosity η (130) of 1.0×10⁴ Pas or less at 130° C., and hence it is possible to sufficiently reduce, in the fixing part, the melt viscosity of the clear toner applied over a toner image in a high density image area. This allows the toner in the high density image area to sufficiently melt, which enables achieving the desired degree of glossiness also in the high density image area and outputting a high-quality image formed by sufficient color mixing. Note that, it is further preferred that the melt viscosity η (130) be 2.5×10³ Pa·s or less.

Note that, to form an image having a high degree of glossiness, a contact fixing step is required, in which a fixing member is brought into direct contact with an unfixed toner image on a transfer material to thereby fix the unfixed toner image onto the transfer material.

In addition, in the case where the clear toner of the present invention is applied to an image forming method adopting a noncontact fixing method, it is possible to achieve toner fixing onto the transfer material with grain boundaries of the toner particles left. By sufficiently leaving the grain boundaries of the toner particles, a clear toner image on the transfer material scatters reflection light, thereby appearing as a white image. Note that, the clear toner of the present invention does not need to include white pigments and metal oxide, which is impurities contained in the white pigments, causing a decrease in the electrostatic charge amount. As a result, a decrease in the electrostatic charge amount due to moisture absorption caused by metal oxide does not take place, thereby preventing the development of a fixing failure and achieving a high-quality white image.

In addition, in the case where the clear toner of the present invention is applied to an image forming method adopting a contact fixing method, it is possible to achieve toner fixing onto the transfer material with a good binding between the toner particles, in which the grain boundaries of the toner particles have sufficiently disappeared. In this case, it is possible to achieve a toner image having a high degree of glossiness.

The clear toner of the present invention is applied to an image forming apparatus including a contact fixing unit and a noncontact fixing unit, and an image is formed by selecting one of the fixing units in accordance with usage. This enables an arbitrary output of any one of a white image and an image having an improved degree of glossiness.

Further, a toner image including the clear toner is fixed by the contact fixing unit to achieve an image having an improved degree of glossiness. Then, a toner image made of the clear toner is formed again on top of the image having an improved degree of glossiness and fixed by the noncontact fixing step. This enables formation of a favorable white image while obtaining a high degree of glossiness.

In addition, in the case of performing the noncontact fixing, as a transfer material therefor, it is preferred to use a transfer material having a receptive layer made of thermoplastic resin on the surface. Using such a transfer material increases a binding force between the toner and the transfer material, thereby further improving the fixing performance of the clear toner in a white image portion. As a result, it is possible to output an even higher-quality white image.

Components contained in the clear toner of the present invention are described in detail.

As a binder resin to be used for the clear toner of the present invention, various resins known as binder resins for toner are used. Of those, a resin having a polyester unit is preferred. Examples of the resin having a polyester unit include i) a polyester resin and ii) a hybrid resin in which a polyester unit and a vinyl-based resin unit are chemically bonded to each other. Those resins may be used alone or in combination of two or more thereof, and may be used as a mixture with a vinyl-based resin or the like.

As a monomer for forming the polyester unit, there may be used, for example, a polyalcohol and a polycarboxylic acid or a polycarboxylic acid anhydride, and a polycarboxylic acid ester. Specifically, as a dihydric alcohol component, there are given: for example, alkyleneoxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, and hydrogenated bisphenol A.

As a trihydric or more alcohol component, there are given, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

As a polycarboxylic acid component and the like, there are given: for example, aromatic dicarboxylic acids such as phthalic acid, isophthalic acid, and terephthalic acid, and anhydrides thereof; alkyldicarboxylic acids such as succinic acid, adipic acid, sebacic acid, and azelaic acid, and anhydrides thereof; succinic acid substituted by an alkyl group having 6 to 12 carbon atoms, and anhydrides thereof; unsaturated dicarboxylic acids such as fumaric acid, maleic acid, and citraconic acid, and anhydrides thereof; and n-dodecenylsuccinic acid and isododecenylsuccinic acid.

Further, in order to form a polyester resin having a crosslinking site, the polyester resin preferably has a trivalent or more polycarboxylic acid component therein. Examples of the trivalent or more polycarboxylic acid component include 1,2,4-benzenetricarboxylic acid, 1,2,5-benzenetricarboxylic acid, 1,2,4-naphthalenetricarboxylic acid, 2,5,7-naphthalenetricarboxylic acid, 1,2,4,5-benzenetetracarboxylic acid, and anhydrides and ester compounds thereof.

The usage of the trivalent or more polycarboxylic acid component is preferably from 0.1 to 1.9 mol % based on the total monomers.

In addition, the hybrid resin is preferably used as the binder resin. In particular, a hybrid resin having a polyester unit as a main chain to which a vinyl-based polymer unit as a side chain is bonded is more preferred. When the hybrid resin is used, additionally satisfactory wax dispersibility and improvements in low-temperature fixability and offset resistance may be expected.

A vinyl-based monomer for generating the vinyl-based polymer unit is exemplified below. Note that, when a vinyl-based polymer is mixed, the following monomers may be used also as a monomer for generating the vinyl-based polymer. For example, there are given: styrene and derivatives thereof, such as styrene, o-methylstyrene, m-methylstyrene, p-methylstyrene, α-methylstyrene, p-phenylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene; styrene unsaturated monoolefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; α-methylene aliphatic monocarboxylates such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylates such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalenes; and acrylic acid or methacrylic acid derivatives such as acrylonitrile, methacrylonitrile, and acrylamide.

Further examples of the vinyl-based monomer include: unsaturated dibasic acids such as maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenylsuccinic anhydride; unsaturated dibasic acid half esters such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half ester, methyl fumarate half ester, and methyl mesaconate half ester; unsaturated dibasic acid esters such as dimethyl maleate and dimethyl fumarate; α,β-unsaturated acids such as acrylic acid, methacrylic acid, crotonic acid, and cinnamic acid; α,β-unsaturated acid anhydrides such as crotonic anhydride and cinnamic anhydride, and anhydrides of the above-mentioned α,β-unsaturated acids and lower fatty acids; and monomers each having a carboxyl group such as alkenylmalonic acid, alkenylglutaric acid, and alkenyladipic acid, and acid anhydrides thereof and monoesters thereof.

Further examples of the vinyl-based monomer include: acrylic acid esters and mathacrylic acid esters such as 2-hydroxyethyl acrylate, 2-hydroxyethyl methacrylate, and 2-hydroxypropyl methacrylate; and monomers each having a hydroxy group such as 4-(1-hydroxy-1-methylbutyl)styrene and 4-(1-hydroxy-1-methylhexyl)styrene.

In the toner of the present invention, the vinyl-based polymer unit of the binder resin may have a crosslinked structure crosslinked with a crosslinking agent having two or more vinyl groups. Examples of the crosslinking agent to be used in this case include the following. There are given: aromatic divinyl compounds such as divinylbenzene and divinylnaphthalene; diacrylate compounds bonded by alkyl chains such as ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those obtained by changing the acrylate of the above-mentioned compounds to methacrylate; diacrylate compounds bonded by alkyl chains each containing an ether bond such as diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and those obtained by changing the acrylate of the above-mentioned compounds to methacrylate; and diacrylate compounds bonded by chains each containing an aromatic group and an ether bond such as polyoxyethylene(2)-2,2-bis(4-hydroxyphenyl)propane diacrylate, polyoxyethylene(4)-2,2-bis(4-hydroxyphenyl)propane diacrylate, and those obtained by changing the acrylate of the above-mentioned compounds to methacrylate.

Examples of the polyfunctional crosslinking agent include: pentaerythritol triacrylate, trimethylolethane triacrylate, trimethylolpropane triacrylate, tetramethylolmethane tetraacrylate, oligoester acrylate, and those obtained by changing the acrylate of the above-mentioned compounds to methacrylate; triallyl cyanurate; and triallyl trimellitate.

In order to obtain the hybrid resin, it is preferred that a monomer component for generating a vinyl-based polymer unit and/or a monomer component for generating a polyester unit contain monomer components capable of reacting with the both unit components. Of the monomer components for generating polyester units, a monomer component capable of reacting with the vinyl-based polymer unit is exemplified by an unsaturated dicarboxylic acid such as phthalic acid, maleic acid, citraconic acid, or itaconic acid, or an anhydride thereof. Of the monomer components for generating vinyl-based polymer units, a monomer component capable of reacting with the polyester unit is exemplified by a monomer component having a carboxyl group or a hydroxy group, an acrylic acid ester, or a methacrylic acid ester.

As a polymerization initiator to be used when the vinyl-based polymer unit or the vinyl-based polymer of the present invention is produced, there are given, for example, 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide, and cyclohexanone peroxide, 2,2-bis(t-butylperoxy)butane, t-butyl hydroperoxide, cumene hydroperoxide, 1,1,3,3-tetramethylbutyl hydroperoxide, di-t-butyl peroxide, t-butylcumyl peroxide, dicumyl peroxide, α,α′-bis(t-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, t-butyl peroxyacetate, t-butyl peroxyisobutyrate, t-butyl peroxyneodecanoate, t-butyl peroxy-2-ethylhexanoate, t-butyl peroxylaurate, t-butyl peroxybenzoate, t-butylperoxyisopropyl carbonate, di-t-butyl peroxyisophthalate, t-butyl peroxyallylcarbonate, t-amyl peroxy-2-ethylhexanoate, di-t-butyl peroxyhexahydroterephthalate, and di-t-butyl peroxyazelate.

As a production method for the hybrid resin, there is given a conventionally known production method such as a method for synthesis involving producing a vinyl-based polymer and a polyester resin separately, dissolving and swelling the resultant polymer and resin in a small amount of an organic solvent, adding an esterification catalyst and an alcohol thereto, and heating the solution to perform a transesterification reaction.

The toner may contain a charge control agent as well. As the charge control agent, a known agent may be employed. In particular, a metal compound of an aromatic carboxylic acid, which is colorless, provides a high charging speed of the toner, and can stably maintain a constant charge amount, is preferred.

As a negative charge control agent, there may be employed, a metal salicylate compound, a metal naphthoate compound, a metal dicarboxylate compound, a polymeric compound having a sulfonic acid or a carboxylic acid in a side chain, a boron compound, a urea compound, a silicon compound, a calixarene, or the like. As a positive charge control agent, there may be employed, a quaternary ammonium salt, a polymeric compound having the quaternary ammonium salt in a side chain, a guanidine compound, an imidazole compound, or the like. Of those, an aluminum 3,5-di-tertiary-butylsalicylate compound is particularly preferred because the compound provides quick rise-up of a charge amount. The charge control agent may be contained in each toner particle (internal addition), or may be mixed with the toner particle (external addition).

The clear toner of the present invention may have added thereto an external additive such as a fluidity improving agent. As the fluidity improving agent to be externally added, a known agent may be employed. In particular, an inorganic fine powder of silica, titanium oxide, aluminum oxide, or the like is preferred. Of those, silica is particularly preferred. The inorganic fine powder is preferably hydrophobized with a hydrophobizing agent such as a silane compound, a silicone oil, or a mixture thereof.

Examples of the hydrophobizing agent include coupling agents such as a silane compound, a titanate coupling agent, an aluminum coupling agent, and a zircoaluminate coupling agent.

Examples of the silane compound include hexamethyldisilazane, vinyltrimethoxysilane, vinyltriethoxysilane, γ-methacryloxypropyltrimethoxysilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-hexadecyltrimethoxysilane, and n-octadecyltrimethoxysilane.

The clear toner of the present invention preferably contains a wax. Examples of the wax include the following: aliphatic hydrocarbon-based waxes such as low-molecular-weight polyethylene, low-molecular-weight polypropylene, an olefin, a microcrystalline wax, a paraffin wax, and a Fischer-Tropsch wax; oxides of aliphatic hydrocarbon-based waxes such as a polyethylene oxide wax or block copolymers thereof; waxes mainly containing fatty acid esters such as a carnauba wax and a montanic acid ester wax; and partially or wholly deacidified fatty acid esters such as a deacidified carnauba wax. Further examples of the wax include: saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyalcohols such as sorbitol; fatty acid amides such as linoleamide, oleamide, and lauramide; saturated fatty acid bisamides such as methylenebisstearamide, ethylenebiscapramide, ethylenebislauramide, and hexamethylenebisstearamide; unsaturated fatty acid amides such as ethylenebisoleamide, hexamethylenebisoleamide, N,N′-dioleyladipamide, and N,N′-dioleylsebacamide; aromatic bisamides such as m-xylenebisstearamide and N,N′-distearylisophthalamide; aliphatic metal salts (which are generally referred to as metal soaps) such as calcium stearate, calcium laurate, zinc stearate, and magnesium stearate; waxes obtained by grafting aliphatic hydrocarbon-based waxes with vinyl-based monomers such as styrene and acrylic acid; partially esterified compounds of fatty acids and polyalcohols such as behenic monoglyceride; and methyl ester compounds each having a hydroxyl group obtained by the hydrogenation of vegetable oils. Of those, hydrocarbon-based waxes are preferred.

Next, procedures for producing the toner are described.

The toner of the present invention is not particularly limited by the production process as long as the toner satisfies desired properties. The toner can be produced by, for example: melting and kneading a binder resin and arbitrary materials; cooling and then pulverizing the melted and kneaded product; performing a classification step as necessary; and mixing the product with external additives as necessary.

First, in a material mixing step, predetermined amounts of individual toner prescriptions are weighed, blended, and mixed. Examples of mixing apparatuses include a double cone mixer, a V-shape mixer, a drum type mixer, a super mixer, a Henschel mixer, and a Nauter mixer. Next, the above-mentioned mixed toner materials are melted and kneaded. In the melting and kneading step, for example, a batch kneader, such as a pressurizing kneader and a Banbury mixer, or a continuous kneader can be used. In recent years, a single-screw or a twin-screw extruder is a mainstream due to advantages of continuous production and the like. In general, the following is, for example, used: a twin-screw extruder model KTK manufactured by Kobe Steel., Ltd.; a twin-screw extruder model TEM manufactured by Toshiba Machine CO., Ltd.; a twin-screw extruder manufactured by KCK CO., Ltd.; and a co-kneader manufactured by Buss Inc. Further, a resin composition obtained by melting and kneading the toner materials is rolled by two rollers or the like, and cooled in a cooling step which is performed with water cooling or the like. Subsequently, in the pulverizing step, the product after the cooling step is pulverized into a desired particle diameter. In the pulverizing step, first, coarse pulverization is performed by a crusher, a hammer mill, a feather mill, or the like, and fine pulverization is further performed by Kryptron System manufactured by Kawasaki Heavy Industries, Ltd., Super Rotor manufactured by Nisshin Engineering Inc., or the like. Then, classification is performed, as necessary, using a sieving machine, such as a classifier, for example, an inertial classification system Elbow-jet (manufactured by Nittetsu Mining Co., Ltd.), a centrifugal classification system Turbo Plex (manufactured by Hosokawa Micron Corp.), and a wind classification system High Bolter (manufactured by ShinTokyo Kikai Co., Ltd.), so as to obtain toner base particles. In addition, in a surface modification step, surface modification and spheronization processing may be performed, as necessary, using a hybridization system manufactured by Nara Machinery CO., Ltd. and a mechanofusion system manufactured by Hosokawa micron Corp., for example. In addition, an air-jet pulverizer may be used, or an apparatus may be used which simultaneously performs classification and surface modification processing using a mechanical impact force. Note that, it is preferred that the toner base particles obtained have a weight average particle diameter (D4) from 3 to 11 μm.

Further, for external addition processing of the external additives, a method may be used in which the classified toner base particles and various well-known external additives are blended in predetermined amounts, and then agitated and mixed using, as an external adding device, a high-speed agitator, such as a Henschel mixer and a super mixer, which imparts a shear force to powder.

In addition, in the case of using the clear toner of the present invention in combination with color toners, well-known pigments and/or dyes may be contained in the color toners.

For example, as a black colorant, there are given, for example, carbon black, acetylene black, lamp black, graphite, iron black, aniline black, and cyanine black.

Further, as a magenta coloring pigment, there are given, for example, C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, 209, or 238, C.I. Pigment Violet 19, and C.I. Vat Red 1, 2, 10, 13, 15, 23, 29, or 35.

As a magenta dye, there are given: for example, oil soluble dyes such as C.I. Solvent Red 1, 3, 8, 23, 24, 25, 27, 30, 49, 81, 82, 83, 84, 100, 109, or 121, C.I. Disperse Red 9, C.I. Solvent Violet 8, 13, 14, 21, or 27, and C.I. Disperse Violet 1; and basic dyes such as C.I. Basic Red 1, 2, 9, 12, 13, 14, 15, 17, 18, 22, 23, 24, 27, 29, 32, 34, 35, 36, 37, 38, 39, or 40, and C.I. Basic Violet 1, 3, 7, 10, 14, 15, 21, 25, 26, 27, or 28.

As a cyan coloring pigment, there are given: for example, C.I. Pigment Blue 2, 3, 15:1, 15:2, 15:3, 16, or 17; C.I. Acid Blue 6; C.I. Acid Blue 45; and a copper phthalocyanine pigment obtained by substituting 1 to 5 phthalimidomethyl groups for a phthalocyanine skeleton.

As a yellow coloring pigment, there are given, for example, C.I. Pigment Yellow 1, 2, 3, 4, 5, 6, 7, 10, 11, 12, 13, 14, 15, 16, 17, 23, 65, 73, 74, 83, 93, 97, 155, or 180, and C.I. Vat Yellow 1, 3, or 20.

In view of a balance between the reproducibility and the coloring power of intermediate colors, the amount of a colorant used is preferably from 3 to 20 parts by mass, further preferably from 6 to 10 parts by mass, with respect to 100 parts by mass of a binder resin.

Note that, methods for measuring the storage elastic modulus and the melt viscosity according to the present invention are as follows.

<Storage Elastic Modulus>

For the measurement of the storage elastic modulus G′ of toner, a dynamic viscoelasticity measuring apparatus RMS-800 (Rheometrics Corp.) was used.

Specifically, first, about 1 gram of a sample was fixed between plates of a parallel plate test fixture (followed by being heated for several minutes at about 110° C.). Then, a strain of a torsion reciprocating motion of 62.8 rad/sec was applied from one of the plates, and a stress with respect to the strain was detected by the other plate. A strain rate at this time was automatically controlled (up to 20%). A temperature was increased in this state to measure the temperature dependence of viscoelasticity. The storage elastic modulus G′ (130) of toner at 130° C. was determined from the measured result.

<Melt Viscosity>

For the measurement of the melt viscosity η of toner, a constant load capillary extrusion rheometer CFD-500 flow tester apparatus (Shimadzu Corp.) was used.

Specific conditions of measurement are as follows.

Dice Diameter: 0.5 mm

Dice Length: 1.0 mm

Total Weight: 500 grams

Rate of Temperature Rise: 4° C./minute

Preheat Time: 420 seconds

Sample Preparation Sample used was prepared by forming 2 grams of toner into a 1-cm pellet.

### EXAMPLES

Hereinafter, the present invention is described by way of specific examples, which are in no way intended to limit the present invention.

### (I) Production Examples of Toners

### Production Example 1 of Clear Toner

(Production of Hybrid Resin (I))

To a dropping funnel were charged, as materials for a vinyl-based copolymer unit, 2.0 mol of styrene, 0.21 mol of 2-ethylhexyl acrylate, 0.16 mol of fumaric acid, 0.03 mol of a dimer of α-methylstyrene, and 0.05 mol of dicumyl peroxide. Further, to a 4-L four-necked flask made of glass were charged, as materials for a polyester unit, 7.0 mol of polyoxypropylene(2.2)-2,2-bis(4-hydroxyphenyl)propane, 3.0 mol of polyoxyethylene(2.2)-2,2-bis(4-hydroxyphenyl)propane, 3.0 mol of terephthalic acid, 2.0 mol of trimellitic anhydride, 5.0 mol of fumaric acid, and 0.2 g of dibutyltin oxide. The four-necked flask was equipped with a thermometer, a stirrer bar, a condenser, and a nitrogen introducing pipe, and was then placed in a mantle heater. Next, the air in the four-necked flask was replaced with nitrogen gas, and the contents were then gradually heated with stirring. To the stirred mixture at a temperature of 140° C. were added dropwise the polymerizable monomers and the polymerization initiator for forming a vinyl-based copolymer unit from the above-mentioned dropping funnel over 4 hours. Next, the mixture was heated to 200° C. and subjected to a reaction for 4 hours to provide a hybrid resin (I).

(Production of Polyester Resin (I))

To a 4-L four-necked flask made of glass were charged 3.5 mol of polyoxypropylene(2.2)-2,2-bis(4-hydroxyphenyl)propane, 1.5 mol of polyoxyethylene(2.2)-2,2-bis(4-hydroxyphenyl)propane, 1.5 mol of terephthalic acid, 1.0 mol of trimellitic anhydride, 2.5 mol of fumaric acid, and 0.1 g of dibutyltin oxide. The four-necked flask was equipped with a thermometer, a stirrer bar, a condenser, and a nitrogen introducing pipe, and was then placed in a mantle heater. The contents were subjected to a reaction under a nitrogen atmosphere at 220° C. for 5 hours to provide a polyester resin (I).

(Production of Wax Dispersion Medium (I))

To an autoclave reaction vessel equipped with a thermometer and a stirring machine were charged 600 parts by mass of xylene and 120 parts by mass of low density polyethylene having a maximum endothermic peak temperature of 110° C., the mixture was sufficiently dissolved, and nitrogen replacement was performed. After that, a mixed solution of 1,992 parts by mass of styrene, 168 parts by mass of acrylonitrile, 240 parts by mass of monobutyl maleate, 78 parts by mass of di-t-butyl peroxyhexahydroterephthalate, and 455 parts by mass of xylene was added dropwise at 175° C. over 3 hours, and the mixture was kept at this temperature for an additional 30 minutes to perform polymerization. Next, the solvent was removed to provide a wax dispersion medium (I) as a graft reaction product.

(Production of Wax Dispersant Master Batch)

Production examples of a wax dispersant and a wax dispersant master batch are described below. A wax (A) was dispersed in the wax dispersion medium (I) at the following blending ratio to provide a wax dispersant (I) formed of the wax (A) and the wax dispersion medium (I).

Wax dispersion medium (I) 50 mass %

Wax (A) (refined normal paraffin wax) 50 mass %

The wax dispersant (I) and the polyester resin (I) obtained as described above were subjected to melt-kneading with a twin-screw extruder at the following blending ratio to provide a master batch of the wax dispersant (I).

| | | |
|---|---|---|
| Wax dispersant (I) | 50 | mass % |
| Polyester resin (I) | 50 | mass % |

(Kneading Step)

| Hybrid resin (I) | 100 | parts by mass |
|---|---|---|
| Polyester resin (I) | 2.55 | parts by mass |
| Master batch of wax dispersant (I) | 16 parts by mass (containing | |
| | 4 parts by mass of wax (A)) | |
| Aluminum compound of 3,5-di-tertiary- | 2 | parts by mass |
| butylsalicylic acid | | |

The above-mentioned materials were preliminarily mixed with a Henschel mixer to a sufficient degree, and subjected to melt-kneading with a twin-screw extruder at an arbitrary barrel temperature.

(Pulverizing Step and Surface-Modifying Step)

The melt-kneaded product was cooled, and was then coarsely pulverized with a hammer mill so as to have a size of about 1 to 2 mm, followed by fine pulverization with a fine pulverizer of an air-jet system. The resultant finely pulverized product was classified to provide clear toner base particles 1.

(External Addition Step)

In this production example, silica which had been subjected to hydrophobizing treatment with a hydrophobizing agent and which had an average primary particle diameter of 20 nm was used as a fluidity improving agent.

100 parts by mass of the clear toner base particles 1 obtained by the above-mentioned production method and 1 part by mass of the above-mentioned silica were charged to a coffee mill, and the coffee mill was repeatedly driven 20 times for 5 seconds each. The process of 20 repetitions of five-second driving was repeated 5 times to externally add a total of 5 parts by mass of the silica.

After the above-mentioned external addition step, aggregates of the toner base particles and the fluidity improving agent were removed with a circular vibrating sieve to provide a clear toner (1) of the present invention. Table 1 shows physical properties of the resultant toner.

### Production Example 2 of Clear Toner

(Preparation of Toner Base Particles)

Toner base particles used were the clear toner base particles 1.

(External Addition Step)

In this production example, a Henschel mixer (FM-75 type, manufactured by Mitsui Miike Kakoki KK) was used as an apparatus for mixing with an external additive.

Further, in this production example, silica which had been subjected to hydrophobizing treatment with a hydrophobizing agent and which had an average primary particle diameter of 15 nm was used as a fluidity improving agent. In addition, an aluminum 3,5-di-tertiary-butylsalicylate compound was used as an external additive for charge control.

To the Henschel mixer (manufactured by Mitsui Miike Kakoki KK) were charged 100 parts by mass of the clear toner base particles 1 and 1 part by mass of the above-mentioned silica, and a stirring blade end tip of stirring blades in which a Y0 blade and an S0 blade were used for an upper blade and a lower blade, respectively, was caused to reach a circumferential speed of 50 m/sec in seconds. After that, mixing was continued for 180 seconds from the start of the mixing while keeping the above-mentioned speed, and the speed was reduced (mixing step 1). The circumferential speed of the stirring blade end tip was reduced to 15 m/sec or less, and the circumferential speed of the stirring blade end tip was kept at 15 m/sec or less for 60 seconds (interruption step 1). Immediately after the lapse of 60 seconds, mixing was resumed, and the stirring blade end tip was caused to reach a circumferential speed of 50 m/sec in 10 seconds. After that, mixing was continued for 180 seconds from the start of stirring while keeping the above-mentioned speed, and the speed was reduced (mixing step 2). The circumferential speed of the stirring blade end tip was reduced to 15 m/sec or less, and the circumferential speed of the stirring blade end tip was kept at 15 m/sec or less for 60 seconds (interruption step 2). Immediately after the lapse of 60 seconds, mixing was resumed, and the stirring blade end tip was caused to reach a circumferential speed of 50 m/sec in 10 seconds. After that, mixing was continued for 180 seconds from the start of the mixing while keeping the above-mentioned speed (mixing step 3). The above-mentioned steps as one cycle is repeated for a total of 6 cycles of the steps. Those cycles as one set were repeated 5 times to perform the step of externally adding a total of 5 parts by mass of silica. Further, in charging the silica in the fifth set, 0.6 part by mass of aluminum 3,5-di-tertiary-butylsalicylate was charged in the Henschel mixer together with 1 part by mass of the silica, and the above-mentioned cycle was performed.

After the above-mentioned external addition step, aggregates of the toner base particles and the fluidity improving agent were removed with a circular vibrating sieve to provide a clear toner (2) of the present invention. Table 1 shows physical properties of the resultant toner.

### Production Example 3 of Clear Toner

(Production of Polyester Resin (II))

To a 4-L four-necked flask made of glass were charged 2.5 mol of polyoxypropylene(2.2)-2,2-bis(4-hydroxyphenyl)propane, 1.5 mol of polyoxyethylene(2.2)-2,2-bis(4-hydroxyphenyl)propane, 1.5 mol of terephthalic acid, 3.0 mol of trimellitic anhydride, 2.5 mol of fumaric acid, and 0.1 g of dibutyltin oxide. The four-necked flask was equipped with a thermometer, a stirrer bar, a condenser, and a nitrogen introducing pipe, and was then placed in a mantle heater. The contents were subjected to a reaction under a nitrogen atmosphere at 220° C. for 5 hours to provide a polyester resin (II).

(Production of Toner Base Particles)

Clear toner base particles 2 were produced in the same manner as in Production Example 1 except that the above-mentioned polyester resin (II) was used in place of the polyester resin (I) used in Production Example 1.

(External Addition Step)

As with the case of Production Example 1, silica which had been subjected to hydrophobizing treatment with a hydrophobizing agent and which had an average primary particle diameter of 20 nm was used as a fluidity improving agent.

The clear toner base particles 2 obtained by the above-mentioned production method were subjected to the same external addition step as in Production Example 1 to externally add a total of 5 parts by mass of the silica.

After the above-mentioned external addition step, aggregates of the toner base particles and the fluidity improving agent were removed with a circular vibrating sieve to provide a clear toner (3) of the present invention. Table 1 shows physical properties of the resultant toner.

### Production Example 4 of Clear Toner

(Preparation of Toner Base Particles)

Toner base particles used were the clear toner base particles 1.

(External Addition Step)

In this production example, as with the case of Production Example 1, silica which had been subjected to hydrophobizing treatment with a hydrophobizing agent and which had an average primary particle diameter of 20 nm was used as a fluidity improving agent.

The clear toner base particles 1 obtained by the above-mentioned production method and 5 parts by mass of the above-mentioned silica with respect to 100 parts by mass of the clear toner base particles were charged to a coffee mill, and the coffee mill was repeatedly driven 4 times for 5 seconds each to externally add 5 parts by mass of the silica.

After the above-mentioned external addition step, aggregates of the toner base particles and the fluidity improving agent were removed with a circular vibrating sieve or the like to provide a clear toner (4). Table 1 shows physical properties of the resultant toner.

### Production Example 5 of Clear Toner

(Production of Polyester Resin (III))

To a 4-L four-necked flask made of glass were charged 2.5 mol of polyoxypropylene(2.2)-2,2-bis(4-hydroxyphenyl)propane, 1.5 mol of polyoxyethylene(2.2)-2,2-bis(4-hydroxyphenyl)propane, 1.5 mol of terephthalic acid, 5.0 mol of trimellitic anhydride, 2.5 mol of fumaric acid, and 0.1 g of dibutyltin oxide. The four-necked flask was equipped with a thermometer, a stirrer bar, a condenser, and a nitrogen introducing pipe, and was then placed in a mantle heater. The contents were subjected to a reaction under a nitrogen atmosphere at 220° C. for 5 hours to provide a polyester resin (III).

(Production of Toner Base Particles)

Clear toner base particles 3 were produced in the same manner as in Production Example 1 except that the above-mentioned polyester resin (III) was used in place of the polyester resin (I) used in Production Example 1.

(External Addition Step)

As with the case of Production Example 1, silica which had been subjected to hydrophobizing treatment with a hydrophobizing agent and which had an average primary particle diameter of 20 nm was used as a fluidity improving agent.

The clear toner base particles 3 obtained by the above-mentioned production method and 1 part by mass of the above-mentioned silica with respect to 100 parts by mass of the toner base particles were charged to a coffee mill, and the coffee mill was repeatedly driven 4 times for 5 seconds each to externally add 1 part by mass of the silica.

After the above-mentioned external addition step, aggregates of the toner base particles and the fluidity improving agent were removed with a circular vibrating sieve or the like to provide a clear toner (5). Table 1 shows physical properties of the resultant toner.

### Production Example 6 of Clear Toner

(Production of Toner Base Particles)

Clear toner base particles 4 were produced by the same production method for toner base particles as in Production Example 1 except that the following kneading step was adopted in place of the kneading step in Production Example 1.

(Kneading Step in this Example)

| Hybrid resin (I) | 100 | parts by mass |
|---|---|---|
| Polyester resin (I) | 2.55 | parts by mass |
| Master batch of dispersant for wax | 16 parts by mass (containing | |
| (A) | 4 parts by mass of wax (A)) | |
| Aluminum compound of 3,5-di-tertiary- | 2 | parts by mass |
| butylsalicylic acid | | |
| Silica which has been subjected to | 5 | parts by mass |
| hydrophobizing treatment with hydro- | | |
| phobizing agent and which has average | | |
| primary particle diameter of 20 nm | | |

The above-mentioned materials were preliminarily mixed with a Henschel mixer to a sufficient degree, and subjected to melt-kneading with a twin-screw extruder.

(Pulverizing Step and Surface-Modifying Step)

Clear toner base particles 4 were obtained after cooling a melt-kneaded product in the same manner as in Production Example 1.

(External Addition Step)

As with the case of Production Example 1, silica which had been subjected to hydrophobizing treatment with a hydrophobizing agent and which had an average primary particle diameter of 20 nm was used as a fluidity improving agent.

The clear toner base particles 4 obtained by the above-mentioned production method and 1 part by mass of the above-mentioned silica with respect to 100 parts by mass of the toner base particles were charged to a coffee mill, and the coffee mill was repeatedly driven 4 times for 5 seconds each to externally add 1 part by mass of the silica.

After the above-mentioned external addition step, aggregates of the toner base particles and the fluidity improving agent were removed with a circular vibrating sieve or the like to provide a clear toner (6). Table 1 shows physical properties of the resultant toner.

### Production Example of Color Toner

(Preparation of Toner Base Particles)

Color toner base particles are obtained by the same production method except that, before the kneading step in Production Example 1 of the clear toner, a colorant-kneaded product is obtained through the following colorant-kneading step, and in the kneading step in Production Example 1, 2.55 parts by mass of the colorant-kneaded product are charged in place of the polyester resin (I).

(Colorant-Kneading Step)

| | |
|---|---|
| Polyester resin (I) | 70 parts by mass |
| Paste pigment having a solid content of 30 mass % | 100 parts by mass |
| (water accounts for the remaining 70 mass %), which | |
| is obtained without a drying step by removing some | |
| water from a pigment slurry before a filtration | |
| step resulting when each colorant is produced by a | |
| known method | |

The polyester resin (I) was first charged to a kneader type mixer, and its temperature was increased under a non-pressurized condition while being mixed. After the temperature had reached its peak (invariably determined by the boiling point of a solvent in the paste. About 90 to 100° C. in this case), hot melt-kneading was performed for an additional 30 minutes. After that, the mixer was stopped for a moment, hot water was discharged, and the temperature was then further increased to 130° C. to perform hot melt-kneading for about 30 minutes. Then, water was distilled away, the resultant was cooled, and a colorant-kneaded product was taken out.

Note that, the following kinds of colorants were used as the solid content colorants in the paste pigments in respective color toners.

Black toner: carbon black

Yellow toner: Pigment Yellow 180

Magenta toner: Pigment Red 122

Cyan toner: Pigment Blue 15:3

(External Addition Step)

In this production example, a Henschel mixer (FM-75 type, manufactured by Mitsui Miike Kakoki KK) was used as an apparatus for mixing with an external additive. Further, silica which had been subjected to hydrophobizing treatment with a hydrophobizing agent and which had an average primary particle diameter of 20 nm was used as a fluidity improving agent.

To the Henschel mixer (manufactured by Mitsui Miike Kakoki KK) were charged the toner base particles obtained by the above-mentioned production method, and 1 part by mass of the above-mentioned silica and 0.6 part by mass of aluminum 3,5-di-tertiary-butylsalicylate with respect to 100 parts by mass of the toner base particles, and a stirring blade end tip of stirring blades in which a Y0 blade and an S0 blade were used for an upper blade and a lower blade, respectively, was caused to reach a circumferential speed of 50 m/sec in 10 seconds. After that, mixing was continued for 180 seconds from the start of the mixing while keeping the above-mentioned speed, and the speed was reduced (mixing step 1). The circumferential speed of the stirring blade end tip was reduced to 15 m/sec or less, and the circumferential speed of the stirring blade end tip was kept at 15 m/sec or less for 60 seconds (interruption step 1). Immediately after the lapse of 60 seconds, mixing was resumed, and the stirring blade end tip was caused to reach a circumferential speed of 50 m/sec in 10 seconds. After that, mixing was continued for 180 seconds from the start of stirring while keeping the above-mentioned speed, and the speed was reduced (mixing step 2). The circumferential speed of the stirring blade end tip was reduced to 15 m/sec or less, and the circumferential speed of the stirring blade end tip was kept at 15 m/sec or less for 60 seconds (interruption step 2). Immediately after the lapse of 60 seconds, mixing was resumed, and the stirring blade end tip was caused to reach a circumferential speed of 50 m/sec in 10 seconds. After that, mixing was continued for 180 seconds from the start of the mixing while keeping the above-mentioned speed (mixing step 3).

After performing the above-mentioned external addition step, aggregates of the toner base particles and the fluidity improving agent were removed with a circular vibrating sieve to produce a color toner.

As a result of keen examination, the inventors of the present invention have found that it is possible to change the storage elastic modulus of toner without changing the melt viscosity of the toner by controlling the adhesion amount and adhesion state of the external additives of the toner. That is, it is considered that a large influence is exerted on the storage elastic modulus of the toner by not only melt properties of resin forming toner base particles but also the adhesion state of inorganic materials on the surface of the toner base particles, and on the other hand, the melt viscosity of the toner is influenced insignificantly by the adhesion state of the inorganic materials on the surface of the toner base particles, but determined by the melt properties of the resin forming the toner base particles. Therefore, an embodiment of the present invention devises conditions of the external additives of the clear toner, thereby enabling adjustment of the storage elastic modulus of the toner while suppressing the change in the melt viscosity of the toner resin.

For example, Production Examples 1 and 4 of the clear toner are compared. Production Examples 1 and 4 differ from each other in the number and time of driving operations of a coffee mill in a process of externally adding silica which has an average primary particle diameter of 20 nm. That is, in the external addition step of Production Example 1, external addition strength is increased by setting the external addition time longer at the time when 1 part by mass of silica is externally added to the toner base particles of the clear toner. Further, by repeating the process of externally adding 1 part by mass of silica five times, it is possible to uniformly disperse a total of 5 parts by mass of silica in the toner base particles of the clear toner with high external addition strength.

On the other hand, as for the external addition step of Production Example 4, when 5 parts by mass of silica is externally added to the toner base particles of the clear toner, the external addition time is short and all the 5 parts by mass of silica is put in at one time. As a result, the silica particles are weakly adherent to the surface of the toner basic particles of the clear toner with the silica particles themselves aggregating together.

Accordingly, the surface properties of the clear toner are very different between Production Examples 1 and 4. As for Production Example 1, silica, which is an inorganic material, is uniformly dispersed on the surface of the toner base particles, and hence binding between toner base particles is less likely to occur at the time of melting. As a result, the clear toner of Production Example 1 is likely to maintain the shape of each toner particle, with the result that the clear toner of Production Example 1 has a higher storage elastic modulus G′ than the clear toner of Production Example 4 at the same temperature.

On the other hand, the melt properties of the toner base particles themselves are less affected by the surface conditions, and hence the melt viscosity η of the clear toner of Production Examples 1 and 4 is of substantially the same order of magnitude.

Those phenomena are not particularly unique to the external addition step using a coffee mill, and similar effects are obtained even when an agitator, such as a Henschel mixer as in Production Example 2, is used. Accordingly, it is evident that the production method for the clear toner of the present invention is not a limitation on the present invention.

TABLE 1

| | G′ (130) | η (130) |
|---|---|---|
| | (Pa) | (Pa · s) |
| Production Example 1 (for Example 1) | 6.00 × 10⁴ | 8.80 × 10² |
| Production Example 2 (for Example 2) | 2.28 × 10⁴ | 8.95 × 10² |
| Production Example 3 (for Example 3) | 1.18 × 10⁴ | 7.63 × 10³ |
| Production Example 4 (for Comparative | 8.91 × 10² | 4.89 × 10² |
| Example 1) | | |
| Production Example 5 (for Comparative | 5.41 × 10⁴ | 9.10 × 10⁴ |
| Example 2) | | |
| Production Example 6 (for Comparative | 1.45 × 10³ | 7.00 × 10² |
| Example 3) | | |

### (II) Image Forming Apparatus

(1) General Overview of Image Forming Apparatus

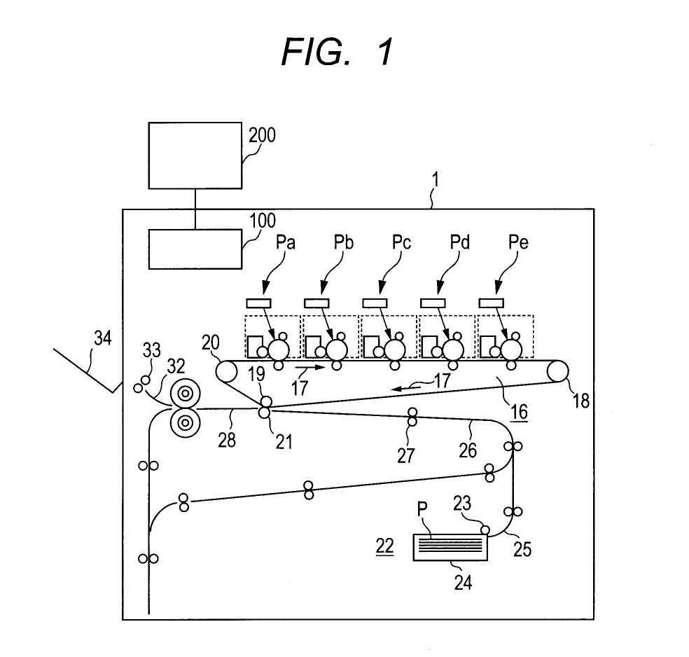

FIG. 1 is a schematic configuration diagram illustrating an embodiment of an image forming apparatus according to the present invention.

An image forming apparatus main body (hereinafter referred to as “apparatus main body”) 1 is a full-color electrophotographic image forming apparatus (tandem-type color recording apparatus). To the apparatus main body 1, an external host apparatus 200, such as a color image reading apparatus and a personal computer, is connected. Various information signals, such as image data, are input from the external host apparatus 200 to a control part (Central Processing Unit, CPU) 100 of the apparatus main body 1. The control part 100 executes image data forming control based on the various information signals input from the external host apparatus 200. Details on the image data forming control are described below.

The apparatus main body 1 includes, inside the apparatus, five image forming parts (color stations, i.e., image forming units), that is, first to fifth image forming parts (Pa to Pe) disposed in tandem sequence starting from left to right in FIG. 1. In addition, the apparatus main body 1 includes an intermediate transfer belt mechanical part 16 on the lower side of the five image forming parts.

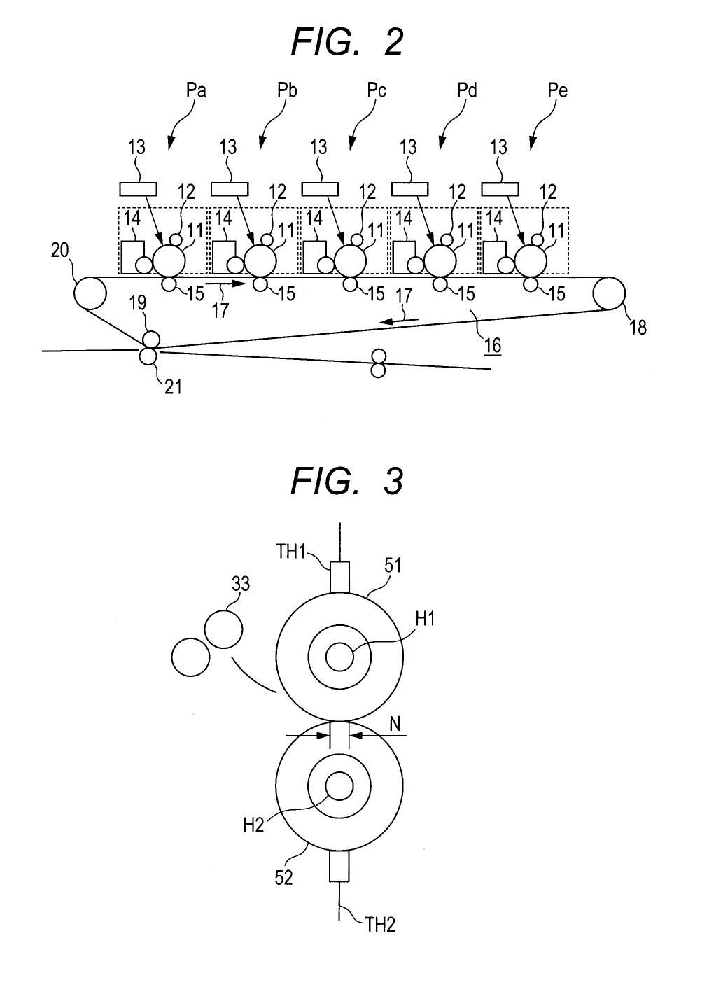

FIG. 2 is an enlarged schematic diagram of a part corresponding to the above-mentioned image forming parts and intermediate transfer belt mechanical part 16. FIG. 3 is an enlarged schematic diagram of a fixing device of the apparatus main body.

All the image forming parts are basically the same electrophotographic process mechanisms, and each of the image forming parts has electrophotographic processing devices as follows:

1) a drum-shaped electrophotographic photosensitive member (hereinafter referred to as “drum”) 11 which is driven to rotate by a drive unit (not shown) in a counterclockwise direction of an arrow at a predetermined speed and functions as an image bearing member;
2) a primary charging device 12 for uniformly charging the surface of the drum to a predetermined potential of a predetermined polarity;
3) a laser scanner unit 13 functioning as an exposing device which forms an electrostatic latent image on the uniformly charged surface of the drum by exposure to a light image L;
4) a developing device 14 for developing the electrostatic latent image formed on the drum to a toner image; and
5) a primary transfer device (primary transfer roller) 15 for forming a primary transfer part T1 by abutting against the drum 11 with the intermediate transfer belt interposed therebetween.

The developing devices have five types of developers, of black, yellow, magenta, cyan, and clear, respectively, and form images according to each of the colors. The specific arrangement can be changed for each example.

The intermediate transfer belt mechanical part 16 includes a flexible endless intermediate transfer belt (hereinafter referred to as “belt”) 17, a driving roller 18 hanging and supporting the belt 17 in a tensioned manner, a secondary transfer opposing roller 19, a tension roller 20, and a secondary transfer roller 21. A part of the belt on the ascending side between the tension roller and the driving roller 18 is laid across the lower surfaces of the drums of the respective image forming parts. The driving roller 18 is driven to rotate, with the result that the belt 17 is driven to rotate in a clockwise direction of arrows at substantially the same speed as the rotating speed of the drums 11.

The primary transfer roller 15 of each image forming part is disposed on the lower side (inner surface side) of the belt 17, and abuts against the lower surface of the corresponding drum 11 with the belt 17 interposed therebetween. With this, a primary transfer nip portion T1 is formed between each of the drums 11 and the upper side (outer surface side) of the belt 17.

The secondary transfer roller 21 abuts against the secondary transfer opposing roller 19 with the belt 17 interposed therebetween. With this, a secondary transfer nip portion T2 is formed between the secondary transfer roller 21 and the surface of the belt 17.

(2) Fixing Device

The fixing device illustrated in FIG. 3 is a heat roller fixing device (oil-less fixing device) for performing a contact fixing step in which a fixing member is brought into direct contact with an unfixed toner image on a transfer material. A fixing roller 51 functions as a fixing member, and a pressure roller 52 functions as a pressurizing member. The fixing roller 51 has an elastic layer on the outer peripheral surface of a hollow metal pipe roller. In addition, a halogen lamp H1 is disposed inside the hollow pipe roller as a heat source. The pressure roller 52 also has an elastic layer on the outer peripheral surface of a hollow metal pipe roller. In addition, a halogen lamp H2 is disposed inside the hollow pipe roller as a heat source. The above-mentioned fixing roller 51 and pressure roller 52 are arranged vertically in parallel to each other and rotatably bearing-supported while being pressurized each other by a pressurizing mechanism to thereby form a fixing nip portion N (10 mm). The fixing roller 51 is driven to rotate in the clockwise direction by a drive source M1. The pressure roller 52 rotates in association with the rotation of the fixing roller 51.

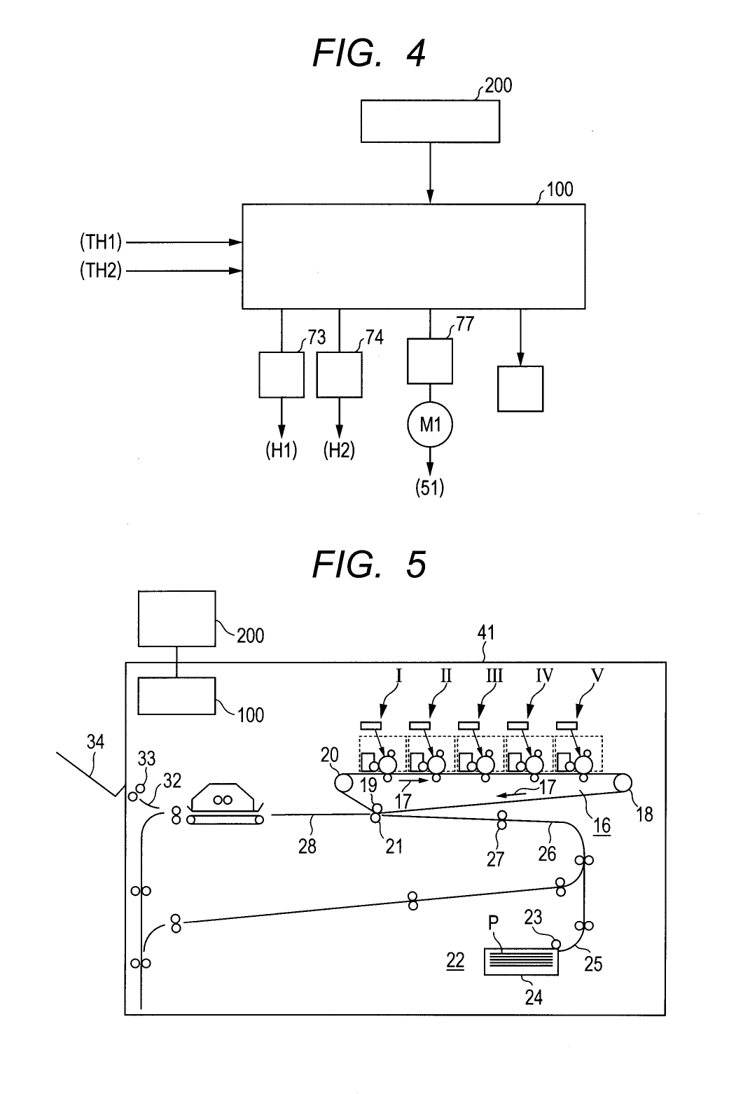

As illustrated in FIG. 4, the control part 100 controls a driver 77 to rotationally drive the fixing roller 51 by the drive source M1. In addition, by controlling power feed parts 73 and 74, the control part 100 feeds power to the halogen lamps H1 and H2 to cause the halogen lamps H1 and H2 to generate heat so as to heat the fixing roller 51 and the pressure roller 52, respectively. The surface temperature of the fixing roller 51 and the pressure roller 52 is detected by thermistors TH1 and TH2, respectively, and the detected temperature information is input to the control part 100. Based on the input detected temperature information, the control part 100 controls power supplied to the halogen lamps H1 and H2 from the power feed parts 73 and 74, respectively, so that the fixing device is regulated to a predetermined temperature.

The control part 100 is capable of adjusting the fixing speed and the regulated temperature of the fixing device by controlling the drive source M1 and the power feed parts 73 and 74.

(3) Image Forming Operations

1) Image Data Forming Control

Image data is input from the external host apparatus 200 to the control part 100 of the apparatus main body 1. The image data to be input herein includes not only color information of an image but also glossy area specifying data for specifying glossiness of arbitrary parts in the image.

The image data input to the control part 100 is color-separated into a yellow component, a magenta component, a cyan component, and a black component, which serve as color toner data. In addition, the glossy area specifying data is converted into a clear component, which serves as clear toner data.

2) Image Forming Process

Referring to FIG. 1, according to image forming process data generated by the above-mentioned image data forming control operations, the first to fifth image forming parts are sequentially driven in accordance with respective image forming timings. In addition, the belt 17 is also driven to rotate. Then, a toner image corresponding to a clear component image in addition to respective toner images corresponding to a black component image, a yellow component image, a magenta component image, and a cyan component image of a color image are formed on the surfaces of the corresponding drums in the respective image forming parts at predetermined control timings. Then, the toner images are sequentially transferred onto the surface of the belt 17 at the corresponding primary transfer nip portions T1 while being superposed on top of each other in a positionally adjusted manner. With this, an unfixed full-color toner image is formed on the belt 17.

In each image forming part, toner remaining on the drum 11 after the primary transfer is removed by a cleaner (not shown). Instead of using the cleaner, a developing and cleaning method may be adopted in which the remaining toner is collected in a developing step.

The unfixed full-color toner image integrally formed on the belt 17 is conveyed by the continuous rotation of the belt 17 to reach the secondary transfer nip portion T2. Then, the unfixed full-color toner image is collectively transferred to a recording material (recording sheet) P which is singly and separately fed from a sheet feeding device 22 and introduced to the secondary transfer nip portion T2 at a predetermined control timing. Toner remaining on the belt 17 after the secondary transfer is removed by a cleaner (not shown).

The recording materials P are stacked one on top of another and received in a sheet feeding cassette 24 of the sheet feeding device 22.

The control part 100 drives a sheet feeding roller 23 of the sheet feeding device 22 to thereby singly and separately feed the recording material P from the sheet feeding cassette 24. Subsequently, the control part 100 causes the recording material P to be conveyed through conveyance paths 25 and 26 and then stopped once at the time when the front edge of the recording material P enters the nip of a registration roller pair 27. Then, the control part 100 drives the registration roller pair 27 at a predetermined control timing with respect to the secondary transfer nip portion T2 to thereby introduce the recording material P into the secondary transfer nip portion T2.

The recording material P after coming out of the secondary transfer nip portion T2 is self-stripped from the surface of the belt 17, and introduced into the fixing device of the apparatus main body 1 through a conveyance path 28.

The recording material P after coming out of the fixing device is guided to an upward conveyance path 32 side, and delivered, as a full-color image formation object, to a first sheet delivery tray 34 provided on the side of the apparatus main body 1 by a sheet delivery roller pair 33.

(4) Evaluation Method

(i) Measurement of Degree of Glossiness

The degree of glossiness was measured by the use of a handy gloss meter, Gloss Meter PG-3D (manufactured by Tokyo Denshoku Co., Ltd.), with a light incidence angle of 60°. As for images used for the measurement, an image patch (5 cm², white portion) formed with the clear toner and an image patch (5 cm², high image density portion) formed by superposing the clear toner on an image of blue, which was a secondary color, were created. Evaluation was performed by measuring the degree of glossiness of the created patches. The degree of glossiness was evaluated in the following three grades:

A: a desired degree of glossiness being obtained.

B: glossiness being rather insufficient compared to the desired degree of glossiness.

C: glossiness being insufficient compared to the desired degree of glossiness.

(ii) Fixing Performance

The image patches created for the measurement of the degree of glossiness were frictionally rubbed ten times in a reciprocating manner with lens-cleaning paper under a pressure of 40 g/cm² exerted by a weight. Fixing performance was evaluated by calculating a decreasing rate (%) of reflection density after the friction rub:

A: decreasing rate of reflection density being less than 5%.

B: decreasing rate of reflection density being 5% or more and less than 10%.

C: decreasing rate of reflection density being 10% or more.

(iii) Color Mixing Performance

The clear toner was superposed on an unfixed image in respective solid secondary colors of red, blue, and green and fixed together to thereby create 25-mm² images. Color mixing performance of each image was visually evaluated:

A: appearing as a bright secondary color with sufficient color mixing.

B: appearing as a secondary color with rather poor color mixing.

C: not appearing as a secondary color with insufficient progression of color mixing.

### Example 1

As for the clear toner, a clear toner (1) obtained according to Production Example 1 of the clear toner was used. As for the black toner, cyan toner, magenta toner, and yellow toner, the above-mentioned individual color toners were used. In addition, as for the output image forming apparatus, an image forming apparatus as illustrated in FIG. 1 was used, and the above-mentioned image evaluation test was conducted. Note that, the image evaluation test was carried out under conditions in which the process speed was 100 mm/s, and, as for the temperature of the fixing roller, the temperature detected by the thermistor TH1 was adjustable to four different temperature settings of 140° C., 160° C., 180° C., and 200° C. In addition, as the recording material P, plain paper weighing 90 g/m² was used. Physical properties of the clear toner used and evaluation results are shown in Table 2.

In Example 1, an image was created by forming an unfixed image of a color toner on the recording material P and superposing, on top of the unfixed image, a clear toner image formed with the clear toner.

### Examples 2 and 3

The image evaluation test was conducted in the same manner as in Example 1, except for using clear toners (2) and (3), respectively. Physical properties of the clear toners used and evaluation results are shown in Table 2.

### Comparative Examples 1 to 3

The image evaluation test was conducted in the same manner as in Example 1, except for using clear toners (4) to (6), respectively. Physical properties of the clear toners used and evaluation results are shown in Table 2.

TABLE 2

| | | | Temperature | Degree of | Fixing | Degree of | Fixing | |
|---|---|---|---|---|---|---|---|---|
| | G′ | η | of fixing | glossiness | performance | glossiness | performance | Color |
| | (130) | (130) | roller | in white | in white | in high image | in high image | mixing |
| | (Pa) | (Pa · s) | (° C.) | portion | portion | density portion | density portion | performance |
| Example 1 | 6.00 × 10⁴ | 8.80 × 10² | 180 | 48 | 2.4 | 49 | 3.2 | A |
| Example 2 | 2.28 × 10⁴ | 8.95 × 10² | 180 | 47 | 1.8 | 48 | 2.8 | A |
| Example 3 | 1.18 × 10⁴ | 7.63 × 10³ | 180 | 41 | 3.1 | 47 | 3.4 | A |
| Comparative | 8.91 × 10² | 4.89 × 10² | 140 | 24 | 7.6 | 12 | 12.5 | C |
| Example 1 | | | 160 | 48 | 2.6 | 25 | 4.8 | B |
| | | | 180 | 17 | 1.8 | 49 | 3.1 | A |
| | | | 200 | 14 | 1.2 | 32 | 2.6 (H.O.) | A |
| Comparative | 5.41 × 10⁴ | 9.10 × 10⁴ | 140 | 5 | 20.7 | 8 | 16.3 | C |
| Example 2 | | | 160 | 13 | 17.6 | 14 | 6.8 | B |
| | | | 180 | 28 | 9.7 | 43 | 3.6 | A |
| | | | 200 | 42 | 4.3 | 29 | 2.8 (H.O.) | A |
| Comparative | 1.45 × 10³ | 7.00 × 10² | 140 | 31 | 6.7 | 15 | 11.3 | C |
| Example 3 | | | 160 | 43 | 3.2 | 29 | 4.3 | B |
| | | | 180 | 18 | 2.7 | 46 | 3.1 | A |
| | | | 200 | 14 | 2.3 (H.O.) | 31 | 2.8 (H.O.) | A |

* H.O.: Hot Offset occured.

Note that, it is considered that an example has the effect of the present invention in the case of having a fixing temperature with Grade ‘A’ in all the evaluation items described above. As for any of Comparative Examples to 3, within the fixing temperature range of 140 to 200° C., there were no fixing temperatures with Grade ‘A’ in all the items.

### Example 4

Hereinbelow, an image forming apparatus according to this example is described.

(1) General Overview of Image Forming Apparatus Example

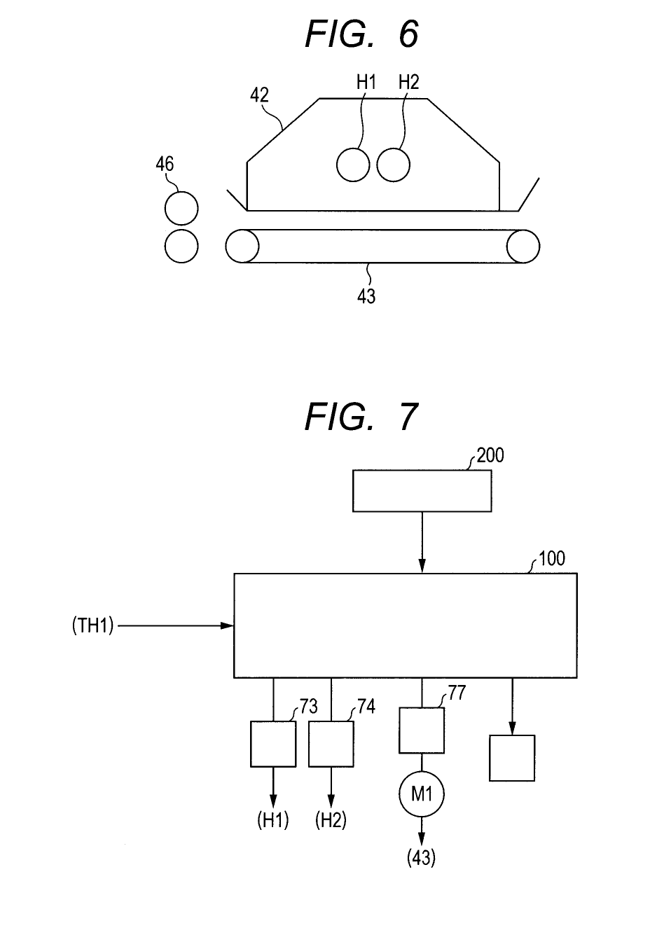

FIG. 5 is a schematic configuration diagram of an image forming apparatus used in this example, including five image forming parts, that is, first to fifth image forming parts (I to V). Unlike the image forming apparatus illustrated in FIG. 1, the fixing device is a noncontact type as illustrated in an enlarged schematic diagram of FIG. 6.

(2) Fixing Device

In this example, a fixing device provided inside an image forming apparatus main body 41 performs a noncontact fixing step in which an unfixed toner image on a transfer material is fixed without being brought into direct contact with a fixing member. The fixing device is an oven fixing device that melts toner on the transfer material by radiation heat. Referring to FIG. 6, a recording material is conveyed with a conveyance belt 43 and conveyance rollers 46. The halogen lamps H1 and H2 are provided, as heating members, inside a reflector assembly 42, and are disposed at a position opposed to the conveyance belt 43. Note that, the inner surface of the reflector assembly 42 is gold-plated in order to increase thermal efficiency.

A noncontact fixing part N (100 mm) is formed by the above-mentioned heating members and conveyance belt 43. The conveyance belt 43 is driven in a counterclockwise direction by the drive source M1.

As illustrated in FIG. 7, the control part 100 controls the driver 77 to drive the conveyance belt 43 by the drive source M1. In addition, by controlling the power feed parts 73 and 74, the control part 100 feeds power to the halogen lamps H1 and H2 to cause the halogen lamps H1 and H2 to generate heat so as to heat the fixing part N. The surface temperature of the conveyance belt 43 is detected by the thermistor TH1 provided inside the conveyance belt 43, and the detected temperature information is input to the control part 100. Based on the input detected temperature information, the control part 100 controls power supplied to the halogen lamps H1 and H2 from the power feed parts 73 and 74, respectively, so that the fixing device is regulated to a predetermined temperature.

The control part 100 is capable of adjusting the fixing speed and the regulated temperature of the fixing device by controlling the drive source M1 and the power feed parts 73 and 74. In this example, the process speed was 30 mm/s, and the heating temperature of the fixing part N was adjusted so that the temperature detected by the thermistor TH1 became 160° C.

Note that, as a noncontact fixing device, the fixing device employing radiation with the use of the halogen lamps is used, however, it is sufficient as long as the fixing device is a noncontact type, that is, the fixing device has a structure in which no pressure is applied to the toner at the fixing part. For example, a well-known fixing method may be used, such as flash fixing using a xenon lamp and hot-air fixing for generating hot air by a heating source and blowing the hot air onto a toner image on a recording material to thereby fix the toner image onto the recording material. In addition, in the case of using a noncontact fixing device, it is preferred to use, as a recording material, resin coated paper having, on at least one surface, a receptive layer made of thermoplastic resin. Due to the formation of the receptive layer made of thermoplastic resin, toner on the transfer material melts at the fixing part, and the thermoplastic resin on the transfer material also melts at the same time. Accordingly, a binding force of the toner on the thermoplastic resin to the transfer material is increased, and the fixing performance in the case of using a noncontact fixing device is further increased. As a result, it is possible to output a higher-quality image.

(3) Image Forming Operations

The image forming operations, except for the fixing step, are the same as in Example 1, and hence the description is omitted.

Effects of the present invention according to this example are described in detail.

As a result of keen examination by the inventors of the present invention, it has become evident that, in the noncontact fixing step, the ease of binding of neighboring toner particles has a correlation with the storage elastic modulus at the time of fixation of the toner. It has been found that when the storage elastic modulus G′ of toner at the time of fixation is high, the neighboring toner particles are less likely to bind to each other and grain boundaries of the toner particles are left. On the other hand, it has been found that the fixing strength of the toner to the recording material has a correlation with the melt viscosity η at the time of fixation, and the fixing performance on the recording material improves as the melt viscosity η at the time of fixation becomes lower.

Therefore, when a clear toner having a storage elastic modulus G′ (130) of 1.0×10⁴ Pa or more at 130° C. is used, a toner image is fixed to a transfer material, in the noncontact fixing step, with grain boundaries of clear toner particles left. In the toner image formed by the clear toner having toner particles whose grain boundaries are sufficiently left, reflection light is scattered. As a result, the hiding power increases so that the toner image appears as white color to thereby become a white toner image. On the other hand, when a clear toner having a melt viscosity η (130) of 1.0×10⁴ Pa·s or less at 130° C. is used, sufficient fixing strength is achieved, thereby enabling favorable fixation onto the recording material.

In view of the above, when image forming was performed in the noncontact fixing step with the use of the above-mentioned clear toner (1), a high-quality white image free from image defects, such as a fixing failure, was achieved. In addition, the clear toner (1) did not include white pigments and metal oxide, which was impurities contained in the white pigments, causing a decrease in the electrostatic charge amount, and hence a decrease in the electrostatic charge amount due to moisture absorption was less likely to take place and the clear toner (1) had favorable electrostatic charging characteristics.

### Comparative Example 4

As for this comparative example, an image evaluation test was conducted using the same configuration as in Example 4, except for using a clear toner (4).

In the case of using the clear toner (4), the storage elastic modulus G′ (130) was 8.91×10² Pa, and hence neighboring clear toner particles were bound together even in the noncontact fixing step. Accordingly, the smoothness of the clear toner image on the transfer material increased, with the result that the clear toner image scattered less reflection light. Therefore, a favorable white image was not achieved.

### Example 5

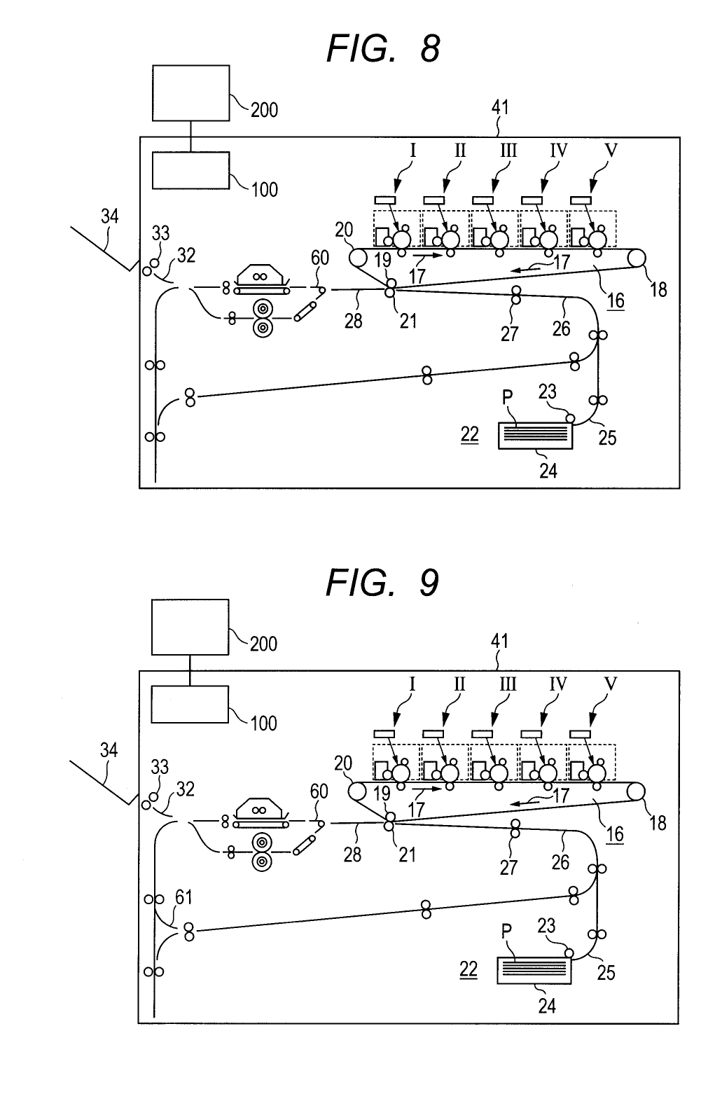

This example uses an image forming apparatus which includes the noncontact fixing device described in the section of Example 4 and the contact fixing device used for Example 1, as illustrated in FIG. 8, and uses the clear toner (1) as a developer.

In addition, the image forming apparatus has a configuration in which, based on input data, the control part 100 causes a fixing device selecting switch 60 to operate. With the operation of the fixing device selecting switch 60, a recording material conveyance path to be used in image forming operations can be selected. With this configuration, the image forming apparatus is able to produce output by sequentially selecting a fixing device to be used in each fixing step.

With the use of the image forming apparatus according to this example, in the case where a fixing step using the contact fixing device is selected via the fixing device selecting switch 60, it is possible to produce a clear toner image having a desired degree of glossiness in a wide range of image density areas, from a white portion to a high image density portion, on the transfer material, as described in the section of Example 1. Further, in the case where a fixing step using the noncontact fixing device is selected via the fixing device selecting switch 60, it is possible to prevent occurrence of the image defects, such as a fixing failure, and output a high-quality white image, as described in the section of Example 3.

As a result, using the image forming apparatus according to this example allows output of a high-quality white image and an image having a desired degree of glossiness in a wide range of image density areas without using multiple clear toners.

### Example 6

According to this example, a fixing member is brought into direct contact with a first unfixed toner image on a transfer material to thereby fix the first unfixed toner image onto the transfer material. Subsequently, a second unfixed toner image is formed again on the same surface of the transfer material using a clear toner, and the second unfixed toner image is fixed onto the transfer material without bringing a fixing member into direct contact with the second unfixed toner image.

According to this example, the image forming apparatus has a conveyance path 61 in post-fixing step conveyance paths, as illustrated in FIG. 9, in addition to the configuration of the image forming apparatus described in the section of Example 5. This allows a recording material, to which toner has been transferred and fixed once in a first image forming process, to be again conveyed to the conveyance path 61. Accordingly, it is possible to again transfer and fix toner to the same surface of the recording material in a second image forming process.

The image forming operations according to this example are briefly described.

By using the contact fixing device in the fixing step of the first image forming, the clear toner (clear toner (a)) sufficiently melts in the fixing nip, which allows formation of an image having a desired degree of glossiness. Then, the formed image on a recording material passes through the conveyance path 61, and in the second image forming process, a clear toner (clear toner (b)) is again transferred to the same surface of the recording material and then fixed to the transfer material by using the noncontact fixing device in the fixing step with grain boundaries of the clear toner particles left. As a result, a favorable white toner image is formed. In this case, grain boundaries have already disappeared from the clear toner image formed in the first image forming process, and hence the clear toner image does not result in white color representation even after the second image forming process.

As a result, by using the image forming apparatus as in this example, it is possible to output an image including, at arbitrary parts on the same image surface of a transfer material, both a white image and an image having an improved degree of glossiness in a wide range of image density areas, from a white portion to a high image density portion.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-278807 filed Dec. 15, 2010, which is hereby incorporated by reference herein in its entirety.

What is claimed is:

1. A clear toner having a storage elastic modulus G′ (130) of 1.0×10⁴ Pa or more at 130° C. and a melt viscosity η (130) of 1.0×10⁴ Pa·s or less at 130° C.

2. An image forming method, comprising a step of fixing an unfixed toner image onto a transfer material by bringing a fixing member into direct contact with the unfixed toner image on the transfer material,
wherein the unfixed toner image comprises a clear toner image formed by using a clear toner, the clear toner image existing on a part of a topmost surface of the unfixed toner image or all area of a topmost surface of the unfixed toner image, and
wherein the clear toner has a storage elastic modulus G′ (130) of 1.0×10⁴ Pa or more at 130° C. and a melt viscosity η (130) of 1.0×10⁴ Pa·s or less at 130° C.

3. An image forming method, comprising a step of fixing an unfixed toner image onto a transfer material without bringing a fixing member into direct contact with the unfixed toner image on the transfer material,
wherein the unfixed toner image comprises a clear toner image formed by using a clear toner, the clear toner image existing on a part of a topmost surface of the unfixed toner image or all area of a topmost surface of the unfixed toner image, and
wherein the clear toner has a storage elastic modulus G′ (130) of 1.0×10⁴ Pa or more at 130° C. and a melt viscosity η (130) of 1.0×10⁴ Pa·s or less at 130° C.

4. An image forming method, comprising:
fixing a first unfixed toner image onto a transfer material by bringing a fixing member into direct contact with the first unfixed toner image on the transfer material;
subsequently forming a second unfixed toner image again on the same surface of the transfer material using a clear toner (b); and
fixing the second unfixed toner image onto the transfer material without bringing a fixing member into direct contact with the second unfixed toner image,
wherein the first unfixed toner image comprises a clear toner image formed by using a clear toner (a), the clear toner image existing on a part of a topmost surface of the first unfixed toner image or all area of a topmost surface of the first unfixed toner image, and
wherein both the clear toner (a) forming the first unfixed toner image and the clear toner (b) forming the second unfixed toner image have a storage elastic modulus G′ (130) of 1.0×10⁴ Pa or more at 130° C. and a melt viscosity η (130) of 1.0×10⁴ Pa·s or less at 130° C.
